(19) United States
(12) Patent Application Publication
(10) Pub. No.: US 2014/0063073 A1
(43) Pub. Date: Mar. 6, 2014

(54) ELECTRONIC DEVICE AND METHOD FOR CONTROLLING MOVEMENT OF IMAGES ON SCREEN

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: CHUNG-I LEE, New Taipei (TW); DE-YI XIE, Shenzhen (CN); SHUAI-JUN TAO, Shenzhen (CN); ZHI-QIANG YI, Shenzhen (CN); JUN-CHAO YAO, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/967,348

(22) Filed: Aug. 15, 2013

(30) Foreign Application Priority Data
Aug. 28, 2012 (CN) 2012103100549

(51) Int. Cl. G06T 3/20; G06F 3/0354

(52) U.S. Cl. CPC G06T 3/20; G06F 3/03543
USPC 345/682

(57) ABSTRACT

In a method for controlling movement of scalable vector graphics (SVG) images which allows display and examination of all parts of an SVG image even when zoomed in, an image display area and an event detection area for the SVG image are determined on a display device. An updated position of the image display area is determined according to current coordinates of a cursor of a mouse on the display device when a mouse event is detected in the event detection area. The SVG image is displayed at an updated position of the image display area, to generate a drag operation of the SVG image on the display device.

### BACKGROUND

1. Technical Field

Embodiments of the present disclosure relate to computer graphics technology, and particularly to an electronic device and method for controlling movement of images on screen.

2. Description of Related Art

Scalable vector graphics (SVG) is an XML-based vector image format for two-dimensional graphics. SVG images and their behaviors are defined in XML text files. This means that they can be searched, indexed, scripted, and, if need be, compressed. The SVG images can be created and zoomed (zoom in or zoom out) randomly.

However, a position of the SVG image cannot be changed when the SVG image is zoomed in on a display screen, thus if the SVG image is zoomed to be larger than the display screen, a portion of the SVG image cannot be displayed on the display screen. Therefore, a more efficient method for controlling movement of SVG images is desired.

### BRIEF DESCRIPTION OF THE DRAWINGS

FIG. 1 is a block diagram of one embodiment of an electronic device including an image controlling system.

FIG. 2 is a schematic block diagram of function modules of the image controlling system included in the electronic device.

FIG. 3 is a flowchart of one embodiment of a method for controlling movement of SVG images.

FIG. 4 is a schematic diagram of an image display area and an event detection area of the SVG images.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other storage medium.

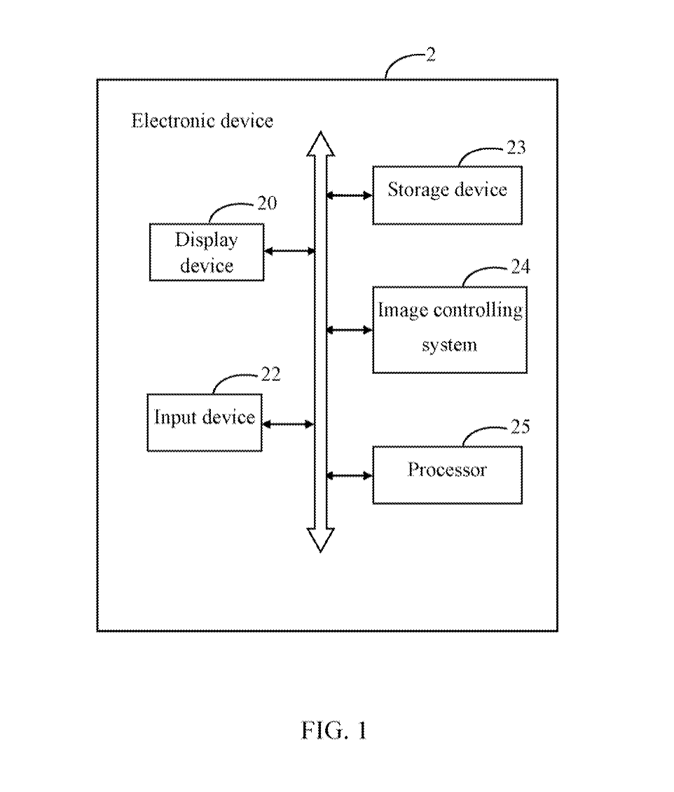

FIG. 1 is a block diagram of one embodiment of an electronic device 2 including an image controlling system 24. In one embodiment, the electronic device 2 further includes a display device 20, an input device 22, a storage device 23, and at least one processor 25. FIG. 1 illustrates only one example of the electronic device 2 that may include more or fewer components than illustrated, or have a different configuration of the various components in other embodiments. The electronic device 2 may be a computer, a mobile phone, or a personal digital assistant (PDA).

The display device 20 displays scalable vector graphics (SVG) images, and the input device 22 may be a mouse or a keyboard for data input. The storage device 23 may be a non-volatile computer storage chip that can be electrically erased and reprogrammed, such as a hard disk or a flash memory card.

In one embodiment, the image controlling system 24 is used to control movements of the SVG image by assigning the occurrence of specified events in relation to a mouse (mouse events), such as a on-click event, a move event, and a mouse release event (e.g., release the left button of the mouse), to an event detection area of the SVG image, and updating a position of the SVG image on the display device 20 in response to receiving a specified event (e.g., a moving operation of the mouse) in the event detection area of the SVG image. The image controlling system 24 may include computerized instructions in the form of one or more programs that are executed by the at least one processor 25 and stored in the storage device 23 (or memory). A detailed description of the image controlling system 24 is given in the following paragraphs.

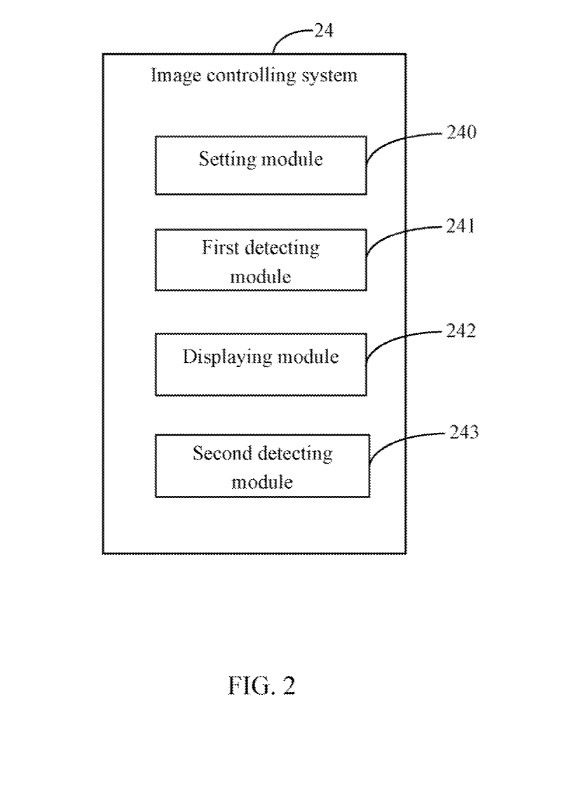

FIG. 2 is a block diagram of function modules of the image controlling system 24 included in the electronic device 2. In one embodiment, the image controlling system 24 may include one or more modules, for example, a setting module 240, a first detecting module 241, a displaying module 242, and a second detecting module 243. In general, the word “module”, as used herein, refers to logic embodied in hardware or firmware, or to a collection of software instructions, written in a programming language. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include flash memory and hard disk drives.

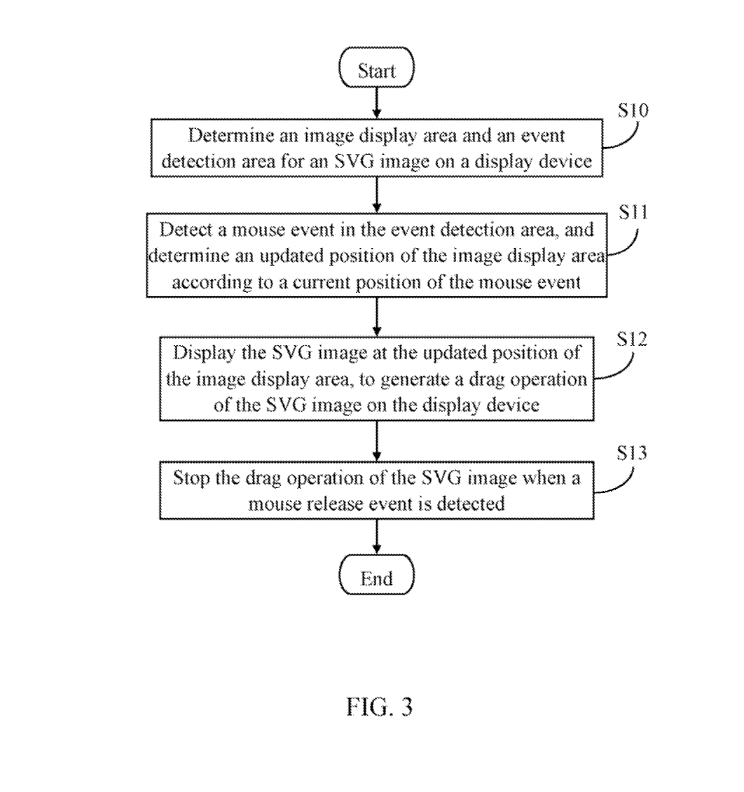

FIG. 3 is a flowchart of one embodiment of a method for controlling movement of SVG images. Depending on the embodiment, additional steps may be added, others removed, and the ordering of the steps may be changed.

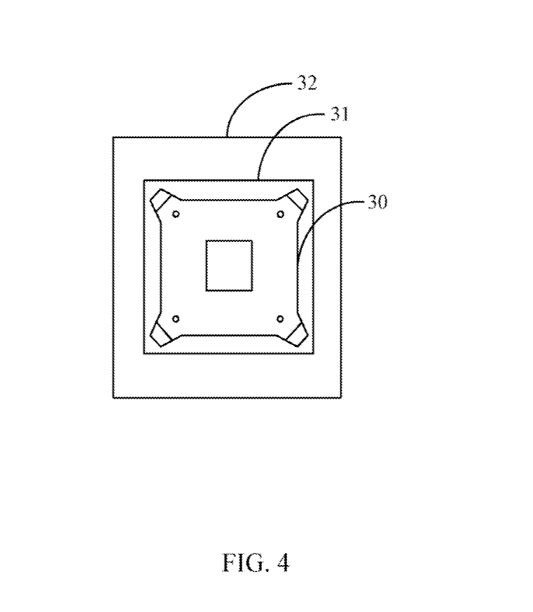

In step S10, the setting module 240 determines an image display area 31 and an event detection area 32 for an SVG image 30 on the display device 20. For example, as shown in FIG. 4, the image display area 31 is a first rectangle enclosing the SVG image 30, such as a smallest rectangle enclosing the SVG image 30. The event detection area 32 is a second rectangle enclosing the image display area 31. In one embodiment, a size of the second rectangle is a predetermined percentage (e.g., 110%) of a size of the first rectangle, or the size of the second rectangle is equal to a surface area of the display device 20.

The image display area 31 is used to display the SVG image 30. The event detection area 32 is used to detect specified mouse events, such as an on-click event (e.g., an onmousedown event), a move event (e.g. an onmousemove event), and a mouse release event (e.g., an onmouseup event). In one embodiment, the boundaries of the image display area 31 and the event detection area 32 are virtual areas on the display device 20, which are not visible to a user.

The setting module 240 further determines an element parameter (or also known as an element variable or a node variable) for storing specified elements of the image display area 31. The specified elements of the image display area 31 may include properties (or attributes) and operating methods of the SVG image 30. For example, the properties of the SVG image 30 may include a width and a height of the SVG image 30. The operating methods of the SVG image 30 may include a drawing method for drawing the SVG image 30 based on the properties of the SVG image 30, and a display method for displaying the SVG image 30 in the image display area 31 of the display device 20. The properties of the SVG image 30 are changed when the SVG image 30 is zoomed in or zoomed out.

In step S11, the first detecting module 241 detects a mouse event in the event detection area 32, and determines an updated position of the image display area 31 according to a current position of the mouse event. The current position of the mouse event is determined as being current coordinates of a cursor (or a pointer) of a mouse on the display device 20. In detail, the first detecting module 241 calculates a translation vector according to the current coordinates of the cursor of the mouse and previous coordinates of the cursor of the mouse at a previous time point, and determines the updated position of the image display area 31 by moving the image display area 31 according to the translation vector (moving the image display area 31 to the current coordinates of the cursor of the mouse). The SVG image 30 is moved synchronously with the image display area 31. For example, if P1(x1, y1) represents the previous coordinates of the cursor, and P2(x2, y2) represents the current coordinates of the cursor, the translation vector is calculated according to a formula of 11 \vec{A}=((x2−x1), (y2−y1)). The coordinate “(x2−x1)” represents an X-axis value of the translation vector, and the coordinate “(y2−y1)” represents a Y-axis value of the translation vector.

The first detecting module 241 assigns the specified elements of the image display area 31 to the element parameter when an on-click event is detected in the event detection area 32, and adds the specified elements in the element parameter to a sub-node of a parent element of the image display area 31. After adding the specified elements in the element parameter to the sub-node of the parent element of the image display area 31, the operations performed on the element parameter are repeated in operations being performed on the image display area 31.

Furthermore, the first detecting module 241 may set a property of a pointer event of the element parameter as none. If the property of the pointer event is set as none, the first detecting module 241 does not detect an on-click event. If the property of the pointer event is set as all, the first detecting module 241 starts to detect the on-click event.

The first detecting module 241 determines whether the element parameter is existed when a move event is detected in the event detection area 32. If the element parameter is existed, the first detecting module 241 determines that the move event happens after the on-click event, that is, the user first clicks the mouse then drags the mouse. The first detecting module 241 assigns the current coordinates of the cursor of the mouse to the element parameter, calculates a translation vector according to the current coordinates of the cursor of the mouse and the previous coordinates of the cursor of the mouse, and determines an updated position of the image display area 31 by moving the image display area 31 according to the translation vector. The SVG image 30 is moved with the image display area 31.

In step S12, the displaying module 242 displays the SVG image 30 at the updated position of the image display area 31 (i.e., a refresh operation), to generate a drag operation of the SVG image 30 on the display device 20.

In step S13, the second detecting module 243 stops the drag operation of the SVG image 30 on the display device 20 when a mouse release event is detected in the event detection area 32. In detail, the second detecting module 243 determines whether the element parameter is existed when the mouse release event is detected in the event detection area 32. If the element parameter is existed, the second detecting module 243 determines that the mouse release event happens after the on-click event. Then, the second detecting module 243 sets the property of the pointer event of the element parameter as all, and deletes the element parameter by assigning a null value to the element parameter.

In other embodiments, the image controlling system 24 may be used to control movements of other images which have features similar to those of SVG images 30, such as raster graphics.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for controlling movement of images using an electronic device, the method comprising:
determining an image display area and an event detection area for a specified image on a display device of the electronic device;
detecting a mouse event trigged in the event detection area, and determining an updated position of the image display area according to current coordinates of a cursor of a mouse on the display device; and
displaying the specified image at the updated position of the image display area, and generating a drag operation of the specified image on the display device.

2. The method according to claim 1, further comprising:
stopping the drag operation of the specified image on the display device when a mouse release event is detected in the event detection area.

3. The method according to claim 1, wherein the specified image is a scalable vector graphics (SVG) image.

4. The method according to claim 1, wherein the image display area is a first rectangle enclosing the specified image, and the event detection area is a second rectangle enclosing the image display area.

5. The method according to claim 1, wherein the updated position of the image display area is determined by:
moving the image display area to the current coordinates of the cursor of the mouse upon a condition that a move event of the mouse is detected in the event detection area after detecting an on-click event in the event detection area; and
determining the current coordinates of the cursor of the mouse as the updated position of the image display area.

6. The method according to claim 5, wherein the image display area is moved by:
calculating a translation vector according to the current coordinates of the cursor of the mouse and previous coordinates of the cursor of the mouse; and
moving the image display area according to the translation vector, the specified image being moved with the image display area synchronously.

7. The method according to claim 5, further comprising:
assigning specified elements of the image display area to a preset element parameter when the on-click event is detected in the event detection area; and
adding the specified elements in the preset element parameter to a sub-node of a parent element of the image display area, and setting a property of a pointer event of the preset element parameter as none.

8. The method according to claim 7, further comprising:
determining whether the preset element parameter is existed when the move event is detected in the event detection area; and
assigning the current coordinates of the cursor of the mouse to the preset element parameter when the preset element parameter is existed, and calculating a translation vector according to the current coordinates of the cursor of the mouse and previous coordinates of the cursor of the mouse.

9. The method according to claim 7, further comprising:
determining whether the preset element parameter is existed when a mouse release event is detected in the event detection area; and
setting the property of the pointer event of the preset element parameter as all, and deleting the preset element parameter by assigning a null value to the preset element parameter.

10. An electronic device, comprising:
a processor;
a storage device storing a plurality of instructions, which when executed by the processor, causes the processor to:
determine an image display area and an event detection area for a specified image on a display device of the electronic device;
detect a mouse event trigged in the event detection area, and determine an updated position of the image display area according to current coordinates of a cursor of a mouse on the display device; and
display the specified image at the updated position of the image display area, and generate a drag operation of the specified image on the display device.

11. The electronic device according to claim 10, wherein the plurality of instructions further comprise:
stopping the drag operation of the specified image on the display device when a mouse release event is detected in the event detection area.

12. The electronic device according to claim 10, wherein the specified image is a scalable vector graphics (SVG) image.

13. The electronic device according to claim 10, wherein the image display area is a first rectangle enclosing the specified image, and the event detection area is a second rectangle enclosing the image display area.

14. The electronic device according to claim 10, wherein the updated position of the image display area is determined by:
moving the image display area to the current coordinates of the cursor of the mouse upon a condition that a move event of the mouse is detected in the event detection area after detecting an on-click event in the event detection area; and
determining the current coordinates of the cursor of the mouse as the updated position of the image display area.

15. The electronic device according to claim 14, wherein the image display area is moved by:
calculating a translation vector according to the current coordinates of the cursor of the mouse and previous coordinates of the cursor of the mouse; and
moving the image display area according to the translation vector, the specified image being moved with the image display area synchronously.

16. The electronic device according to claim 14, wherein the plurality of instructions further comprise:
assigning specified elements of the image display area to a preset element parameter when the on-click event is detected in the event detection area; and
adding the specified elements in the preset element parameter to a sub-node of a parent element of the image display area, and setting a property of a pointer event of the preset element parameter as none.

17. The electronic device according to claim 16, wherein the plurality of instructions further comprise:
determining whether the preset element parameter is existed when the move event is detected in the event detection area; and
assigning the current coordinates of the cursor of the mouse to the preset element parameter when the preset element parameter is existed, and calculating a translation vector according to the current coordinates of the cursor of the mouse and previous coordinates of the cursor of the mouse.

18. The electronic device according to claim 16, wherein the plurality of instructions further comprise:
determining whether the preset element parameter is existed when a mouse release event is detected in the event detection area; and
setting the property of the pointer event of the preset element parameter as all, and deleting the preset element parameter by assigning a null value to the preset element parameter.
